(19) United States
(12) Patent Application Publication
(10) Pub. No.: US 2021/0007179 A1
(43) Pub. Date: Jan. 7, 2021

(54) MOBILE COMMUNICATION SYSTEM FOR GATHERINGS LIMITED TO A SPECIFIC GEOGRAPHIC AREA SUCH AS CRUISE LINES

(71) Applicants: Frank Levy, Fort Myers, FL (US); Kimberley Levy, Fort Myers, FL (US)

(72) Inventors: Frank Levy, Fort Myers, FL (US); Kimberley Levy, Fort Myers, FL (US)

(21) Appl. No.: 17/022,601

(22) Filed: Sep. 16, 2020

Related U.S. Application Data
(63) Continuation-in-part of application No. 15/194,095, filed on Jun. 27, 2016, now abandoned.
(60) Provisional application No. 62/185,328, filed on Jun. 26, 2015.

(51) Int. Cl. H04W 84/18; H04W 4/14; H04W 4/06; H04W 4/021

(52) U.S. Cl. CPC H04W 84/18; H04W 4/022; H04W 4/06; H04W 4/14

(57) ABSTRACT

A mobile communication system allows for communication in a limited geographic area without the need for conventional communication infrastructure. The communication system includes a plurality a mobile communication texting devices operated by users of the mobile communication system, a central server operated by a host of the mobile communication system, and a plurality of mesh routers wirelessly coupled to a gateway node. The plurality of mobile communication texting devices interact and communicate amongst themselves by utilizing the mesh routers, the gateway node and the central server.

### CROSS REFERENCE TO RELATED APPLICATION

This application is a continuation-in-part of U.S. patent application Ser. No. 15/194,095, filed Jun. 27, 2016, which claims the benefit of U.S. Provisional Patent Application Ser. No. 62/185,328, entitled “MOBILE COMMUNICATION SYSTEM FOR GATHERINGS LIMITED TO A SPECIFIC GEOGRAPHIC AREA SUCH AS CRUISE LINES,” filed Jun. 26, 2015, both of which are incorporated herein by reference.

### BACKGROUND OF THE INVENTION

### 1. Field of the Invention

The present invention relates to a mobile communication system. More particularly, the invention relates to a mobile communication system providing access amongst various users within a limited geographic area, for example, travelers aboard a cruise line, convention events, or any group communications within a specified area.

### 2. Description of the Related Art

In 2010 a record 15 million passengers were forecasted to have cruised, with 11.1 million originating in North America. The cruise industry is the fastest-growing category in the leisure travel market. Since 1980, the industry has experienced an average annual passenger growth rate of approximately 7.4% per annum. Since 1990, over 169 million passengers have taken a 2+ day cruise. Of this number, over 67% of the total passengers have been generated in the past 10 years and nearly 40% in the past 5 years. The average length of cruises is nearly 7 days (7.2 days).

Throughout its history the industry has responded to the vacation desires of its guests and embraced innovation to develop new destinations, new ship designs, new and diverse onboard amenities, facilities and services, plus wide-ranging shore activities. Cruise lines have also offered their guests new cruise themes and voyage lengths to meet the changing vacation patterns of today's travelers.

The cruise industry's establishment of over 30 North American embarkation ports has provided consumers with unprecedented convenience, cost savings and value by placing cruise ships within driving distance of 75% of North American vacationers. By providing significant cost savings through the convenience of avoiding air travel, the new home-ports have introduced leisure cruising to a wider customer base.

The one thing lacking in the whole “cruising experience” is the ability to communicate with other members of your cruising party. Cruisers primarily travel with their spouse (75%), followed by children under 18 (25%), friends (23%), and other family members (21%). Complicating the ability of cruisers to communicate while at sea are theme cruises, and the various types of business cruises, where fellow cruisers are not family members or friends.

Many of today's cruisers can't bear to abandon their tech toys and connections to friends and family, even at sea. Increasingly, major cruise lines are fielding a barrage of high-tech guest options—from Wi-Fi hot spots to cabin data ports, from cell phone service to iPods and computer classes. Silversea® Cruises reports 65 percent of its guests use some form of onboard Internet access, while 50 percent are using cell phones at sea.

In many venues, cell phone calls are discouraged or not even permitted due to their disturbance of other guests/attendees. Ringing of a cell phone, or oral conversations on a cell phone, disturbs other guests/attendees.

Further still, the recent pandemic has made it clear that gatherings of people at events within a limited area, for example, travelers aboard a cruise line, convention events, or any group communications within a specified area, represent a distinct problem with the transmission of disease.

### SUMMARY OF THE INVENTION

It is, therefore, an object of the present invention to provide a mobile communication system allowing for communication in a limited geographic area without the need for conventional communication infrastructure. The communication system includes a plurality a mobile communication texting devices operated by users of the mobile communication system, a central server operated by a host of the mobile communication system, and a plurality of mesh routers wirelessly coupled to a gateway node. The plurality of mobile communication texting devices interact and communicate amongst themselves by utilizing the mesh routers, the gateway node and the central server. Each of the plurality of mobile communication texting devices includes a housing with a battery, a microprocessor, a memory, an antenna, a display device, a GPS module enabling real time detection of a current geographic position of each of the plurality of mobile communication texting devices, a contact tracing module, and a wireless communication module interconnected to provide for communication with other communication texting devices

It is also an object of the present invention to provide a mobile communication system wherein the gateway node is integrated into the central server.

It is a further object of the present invention to provide a mobile communication system wherein the wireless communication module includes a radio transmitter/receiver connected with the antenna.

It is another object of the present invention to provide a mobile communication system wherein the mobile communication texting device includes no mechanism for voice communication and is limited to communications via SMS (Short Message Service).

It is a further object of the present invention to provide a mobile communication system wherein the mobile communication system is part of a cruise ship.

Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is a schematic of the mobile communication texting device of the present invention.

FIGS. 2 and 3 are schematics of the networks employed in the implementation of the present system.

FIG. 4 is a schematic of the mobile communication texting device of the present invention in accordance with an alternate embodiment.

### DESCRIPTION OF THE PREFERRED EMBODIMENTS

The detailed embodiments of the present invention are disclosed herein. It should be understood, however, that the disclosed embodiments are merely exemplary of the invention, which may be embodied in various forms. Therefore, the details disclosed herein are not to be interpreted as limiting, but merely as a basis for teaching one skilled in the art how to make and/or use the invention.

The present mobile communication system 100 allows for communication in a limited geographic area without the need for conventional communication infrastructure and where such conventional communication infrastructure may not be available, may be discouraged and/or may not permitted. In accordance with one application, the mobile communication system 100 of the present invention is intended for use in conjunction with cruise ships 102, although other applications, for example, medical meetings, educational symposiums, trade shows, sporting events, military events, conference centers, amusement parks, secure facilities, etc., are certainly possible and contemplated. With this in mind, the following disclosure is focused upon use on a cruise line although it is fully appreciated other uses are certainly possible.

The present mobile communication system 100 offers benefits for the clients, their advertising partners, and the end users. These can be summed up in five main areas. First, the present mobile communication system 100 provides the ability for groups as large as corporations and as small as families to stay in contact with one another, schedule gatherings, dinners, excursions, and more while traveling at sea, or during conference events. Second, the present mobile communication system 100 provides access in areas where cell phones are not accessible, not cost-effective, or just undesired. Third, the present mobile communication system 100 provides ship 102 to passenger (or other users of the present mobile communication system) 104 communications for alerts, special events, and special offers in an immediate manner. Fourth, the present mobile communication system 100 has no ringing mechanism that might disturb other passengers. Fifth, the present mobile communication system 100 offers the opportunity for direct advertising from the operator (or host) of the mobile communication system 100 to the users 104 of the present mobile communication system 100.

The present mobile communication system 100 includes a plurality a mobile communication texting devices 10 operated by users 104 of the present mobile communication system 100 and a central server 106 operated by the host of the present mobile communication system 100. In accordance with a preferred embodiment, and as will be appreciated based upon the following disclosure, the present mobile communication system 100 also includes a plurality of mesh routers 108 wirelessly coupled to a gateway node 110 (that may be integrated into the central server 106). The plurality of mobile communication texting devices 10 interact and communicate amongst themselves by utilizing the mesh routers 108, the gateway node 110 and the central server 106.

In accordance with a preferred embodiment, the present mobile communication system 100, and as such the plurality of mobile communication texting devices 10 operating and associated with the central server 106, employs a wireless mesh network, for example, a cloud-based wireless mesh network as provided by OPEN-MESH®, for the networking of the mobile communication texting devices within the confines of a cruise ship, or events within a similar geographic area.

As those skilled in the art will appreciate, a wireless mesh network is a communications network made up of radio nodes organized in a mesh topology. In accordance with the present implementation, the wireless mesh network includes mesh clients (that is, the plurality of mobile communication texting devices 10), mesh routers 108 and gateway nodes 110. The mesh routers 108 forward traffic to and from the gateway nodes 110 which may, but need not, connect to the Internet.

The coverage area of the radio nodes working as a single network is sometimes called a mesh cloud. Access to this mesh cloud is dependent on the radio nodes working in harmony with each other to create a radio network. A mesh network is reliable and offers redundancy. When one node can no longer operate, the rest of the nodes can still communicate with each other, directly or through one or more intermediate nodes. Wireless mesh networks can be implemented with various wireless technologies and/or protocol standards including Institute of Electrical and Electronics Engineers (IEEE) 802.11, IEEE 802.15, IEEE 802.16, cellular technologies or combinations of more than one type.

Mesh networks develop dynamic networks. Each mesh client initially explores its surrounding geographic area by transmitting its own identity and features via broadcasts (message to all other mesh clients). As each mesh client performs this process, the mesh client detects which devices operate within its radio range or surrounding geographic area. The signal quality of these devices is established, for example through the packet loss rate, signal-to-noise ratio or selected bit rate of the WLAN's (Wireless Local Area Network) rate control algorithm. This signal quality is incorporated into the metrics used to evaluate and compare routes. Finally, information about the routes is transmitted from device to device. The mesh node's mesh algorithm does not rely on complex path finding algorithms; instead, the optimum route is detected implicitly through the packets sent, each participant transmitting route packets featuring metrics of one hundred. From this process a mesh network is developed.

As to the mobile communication texting device 10 employed in accordance with a preferred embodiment of the present invention, each of the plurality of mobile communication texting devices 10 is a rectangular device shaped and dimensioned to hang from a lanyard or fit within the pocket of a user 104 of the mobile communication system 100. The mobile communication texting device 10 includes a housing 11 having a plurality of electronic components housed therein. Since the mobile communication texting device 10 is only intended for the limited purpose of “texting”, full communication capabilities are not required for the implementation of the mobile communication system 100. Each of the present mobile communication texting devices 10 includes a battery 12, a microprocessor 14, a memory 16, an antenna 18, and a wireless communication module 20 interconnected in a conventional manner to provide for communication with other communication texting devices 10. It is appreciated the electronic operating components may be integrated onto a single circuit board. The wireless communication module 20 generally incorporates a radio transmitter/receiver 22 connected with the antenna 18. As such, the radio transmitter/receiver 22, in conjunction with the antenna 18, performs wireless communication.

In accordance with a preferred embodiment, the wireless communication module 20 operates in conjunction various wireless technology including IEEE 802.11, IEEE 802.15, IEEE 802.16. As those skilled in the art appreciate, IEEE 802.11 is a set of media access control (MAC) and physical layer (PHY) specifications for implementing WLAN computer communication in the 2.4, 3.6, 5 and 60 GHz frequency bands. IEEE 802.15 is a working group of the IEEE 802 Standards Committee which specifies wireless personal area network (WPAN) standards, and includes seven task groups. IEEE 802.16 is a series of Wireless Broadband standards officially called WirelessMAN in IEEE, which has been commercialized under the name “WiMAX” (from “Worldwide Interoperability for Microwave Access”) by the WiMAX Forum industry alliance.

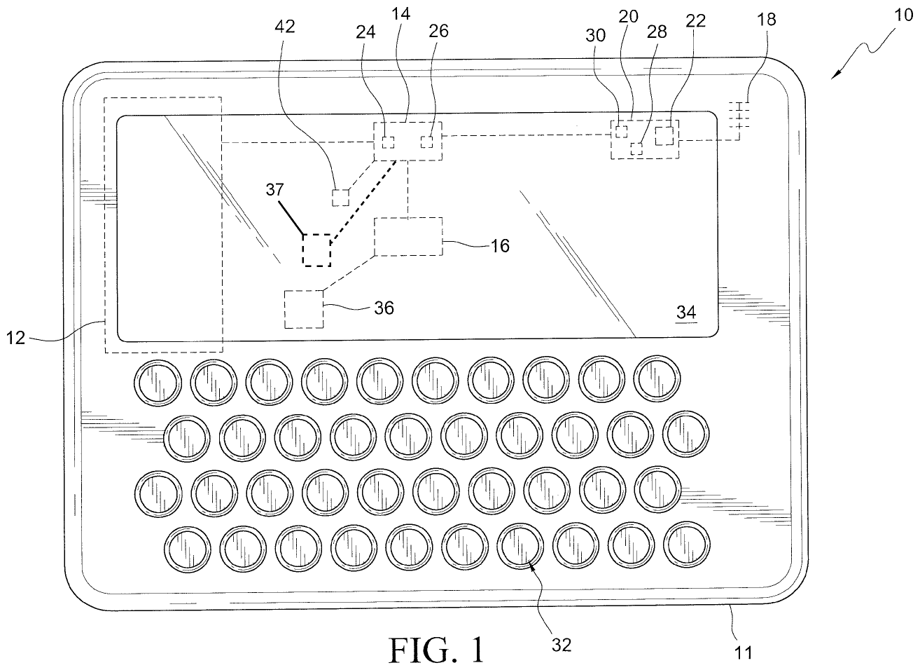

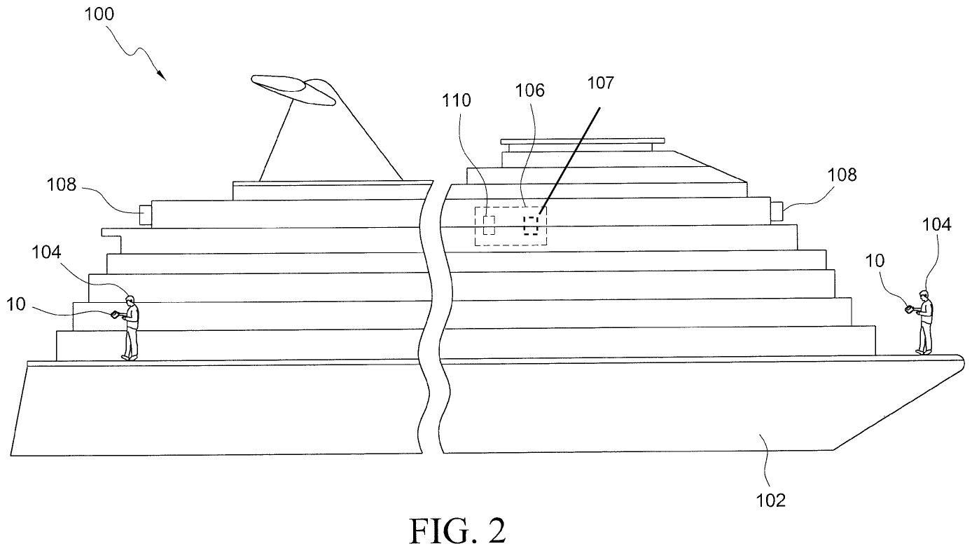

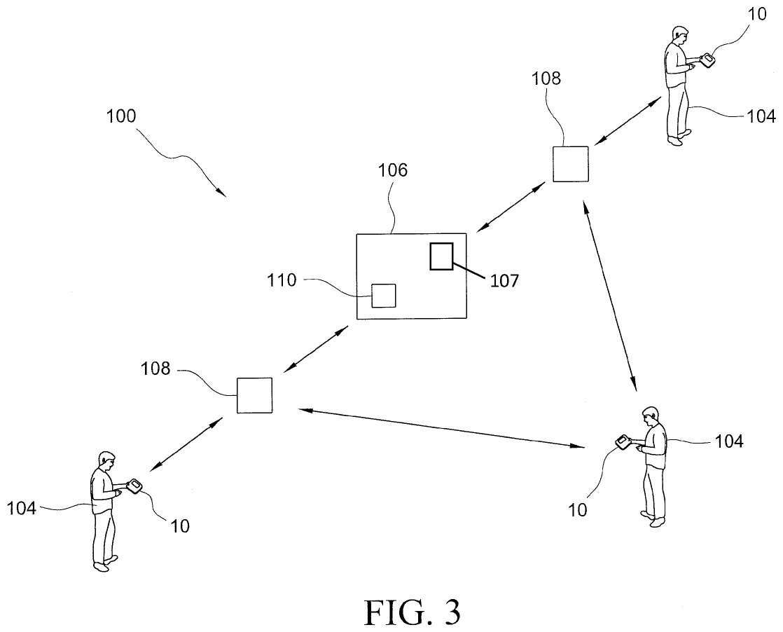

A representation of a mobile communication texting device 10 in accordance with a preferred embodiment of the present invention is disclosed with reference to FIG. 1. In accordance with a preferred embodiment, each of the mobile communication texting devices 10 is the size of a playing card (only slightly thicker to accommodate the associated electronics). The mobile communication texting device 10 is lightweight for comfort and ease of handling. It has an attached lanyard, and can be worn around the neck, pinned to clothing, or placed in a pocket/purse/backpack.

The internal circuit of the mobile communication texting device 10 preferably includes a baseband digital signal processor 24, which handles the communication functions and an applications processor 26, on which the menu and other applications, for example, an operating system and user application, executes and/or runs. Both the digital signal processor 24 and the applications processor 26 are integrated with the microprocessor 14 discussed above. The antenna 18 is connected to the communication module 20 supporting a specific subscriber number. The wireless communication module 20 comprises circuitry for completing wireless communication (transmit and receive data signals) via the antenna 18, including for example, a RF transceiver 28 and a power amplifier module 30.

As is appreciated in the art, the baseband digital signal processor 24 is coupled to an interface application specific integrated circuit (ASIC), and other input/output devices provided in the mobile communication texting device 10, such as a numeric or alphanumeric keypad 32 built into the housing 11 of the mobile communication texting device 10 (or implemented via a touchscreen of the mobile communication texting device in accordance with an alternate embodiment) for entering commands, text, numbers, data, and/or other information. The mobile communication texting device 10 also includes a display device 34, which serves as an output (video) device. Input mechanisms utilizing the keypad 32 are achieved in a convention manner, and therefore include selection buttons or icons for selection menu functions and other tools and options provided by various utilities provided by the mobile communication texting device 10.

The interface mechanism displayed upon the display device 34 is a conventional graphical user interface (via LCD (liquid crystal display) color display). The graphical user interface includes a plurality of function buttons/icons, which are appropriately designed to support the functionalities contemplated for use in accordance with the present invention. The present mobile communication texting device may also include a GPS (global positioning system) module 36, enabling real time detection of a current geographic position of mobile communication device and any movement of mobile communication device.

With the inclusion of the GPS module 36 comes the functionality of contact tracing for users of the present mobile communication system 100. In particular, the GPS module 36 is linked to a contact tracing module 37 (via the microprocessor 14) that monitors close proximity interactions between users of the present mobile communication system 100. The contact tracing module 37 is continually in contact (via the microprocessor 14 and the wireless communication module 20) with a contact tracing control system 107 on the central server 106 of the mobile communication system 100.

The contact tracing control system 107 continually monitors user proximity information and when an individual tests positive for a virus (or other pathogen) the contact tracing control system 107 sends out a message to all users that they may have come in close contact with someone testing positive for a virus (or other pathogen).

While a GPS based contact tracing system is implemented in accordance with a disclosed embodiment of the present invention, it is appreciated other contact tracing systems may be used, for example, Bluetooth based contact tracing systems, without departing from the spirit of the present invention.

In accordance with a preferred embodiment, the digital signal processor 24 uses a flash memory for code storage. Further, a SDRAM (synchronous dynamic random access memory) and flash memory provide volatile and non-volatile memory, respectively, for the applications processor 26. This arrangement of memory holds the code for the operating system, the code for customizable features such as the directory of the mobile communication texting device 10, and the code for any embedded applications software in the mobile communication texting device 10.

In addition, the mobile communication texting device 10 will notify users 104 via vibrations or a light up mechanism, with no ringing capability. As such, the mobile communication texting device 10 will include a vibration device 42 as is known to those skilled in the art. In addition, the display may incorporate backlighting technology for use in the dark, and may have a dedicated button to turn on the light for conserving power. It is also appreciated the light may timeout for power conservation. Still further, each user will be able to program their mobile communication texting device 10 with the contact names of the people in their own sub group for proper identification for texting. The operator will, however, be able to access the various mobile communication texting devices 10 and make any changes or send messages to the entire group.

As briefly discussed above, the present mobile communication texting device 10 offers limited functionalities keeping with the goal of providing a simplified, utilitarian device that people may take advantage of for a limited time. In accordance with a preferred embodiment, the mobile communication texting device 10 includes no mechanism for voice communication and is limited to communication via SMS (Short Message Service). As those skilled in the art appreciate, SMS is a text messaging service component of phone, Web, or mobile communication systems. It uses standardized communication protocols to allow for the exchange of short text messages. The use of SMS in accordance with the present invention allows for contacting limited parties within a geographic area and/or messaging to one, or to all or a selected plurality of, party(ies) in possession/use of a mobile communication texting device 10 in accordance with the present invention.

The system described herein allows for the set-up of hundreds of sub-groups upon distributing the mobile communication texting devices 10. These groups can be as small as 2 people and as large as hundreds of people. In practice, users will submit their groups to an administrator and the administrator will set up the various sub-groups. In this way, all members of each sub-group will receive respective groups' text messages.

It is appreciated the hardware and configuration depicted herein may vary depending on implementation, and that the schematic is merely representative and is not meant to imply architectural limitations with respect to the present invention.

After each cruise/event/conference (or other use as might be implemented in accordance with the functionalities of the present invention), the mobile communication texting device 10 will be returned for cleaning and testing, and ultimately for reuse on the next event. If the mobile communication texting device 10 is not returned or is returned damaged, it will be flagged and the appropriate credit card charges will be applied to the customer.

Being a device designed for “single application use” (sending & receiving text messages only) the actual weight of the present mobile communication texting device 10 will be compact and minimal. Using a Mesh network/private intranet, the present system 100 is able to piggyback the ship's/event's existing WiFi network without slowing down the hosting network. The present system does not require Internet access, and therefore is completely transparent to the existing Internet users on board, or in limited WiFi areas. With the foregoing in mind, the present invention provides an inexpensive solution that will enable operators of the present mobile communication system 100 to establish a private intranet on each cruise ship 102. The present system 100 employs a plurality of mobile communication texting devices 10 used in conjunction with a dedicated central server 106 set up on board each ship/event to facilitate all text processing to a predetermined number of mobile communication texting devices 10, which may amount to over 3,000 devices. The OPEN-MESH® wireless mesh communication network is designed precisely for these types of large, modular, local networks.

Implementation of this technology will enhance and maximize passenger experience, as well as enable the cruise line to communicate with every passenger aboard in a real-time manner. This allows for new marketing procedures in advertising by mass text for cruise lines, and group events, nationally.

The keys to the success of the present mobile communication system 100 rest in the speedy integration and overall acceptance by the hosts. Along these lines the operator of the present mobile communication system 100 will also need to implement direct marketing strategies to the target markets. Hence the key success factors to the rollout of the present mobile communication system 100 include ease in adoption, minimal invasiveness, cost effectiveness, risk free trials and the potential for additional revenue opportunities.

The present mobile communication system 100 penetrates a lucrative market in a rapidly growing industry. The current increase in social networking, coupled with, the ever growing leisure travel and business market presents an opportunity for the present mobile communication system 100 to not only be the first player in this market, but also own the majority of this new frontier.

In putting the present mobile communication system 100 together enough services are offered to create demand. However, technological developments provide opportunities for the various organizations. As such, it is appreciated there is also the possibility to introduce m-commerce in the form of banners, alerts, messaging, and advertising opportunities, as we will have the necessary infrastructure in place. The art of m-commerce relies on the convergence of Internet technologies, mobile devices, cellular phones, band-width and a whole lot of companies champing at the bit of m-commerce. M-commerce is about being able to transact business through any portable intelligent device.

It is also appreciated lead retrieval technology may be integrated into the mobile communication texting device 10 and mobile communication system 100. Such technology would provide a mechanism for capturing, analyzing and subsequently applying leads generated at events, trade shows, and/or conferences employing the present system. The mobile communication texting device 10 may further provide for GPS tracking (with option to turn off), banners/advertising capability, emergency alerts, and vibratory alerts.

Ideally, each venue will integrate the technology across their entire passenger/guest/registrant list and have it available at no extra charge to each and every guest. This would exponentially increase revenue potential as the advertising would be sent to each and every person with the device.

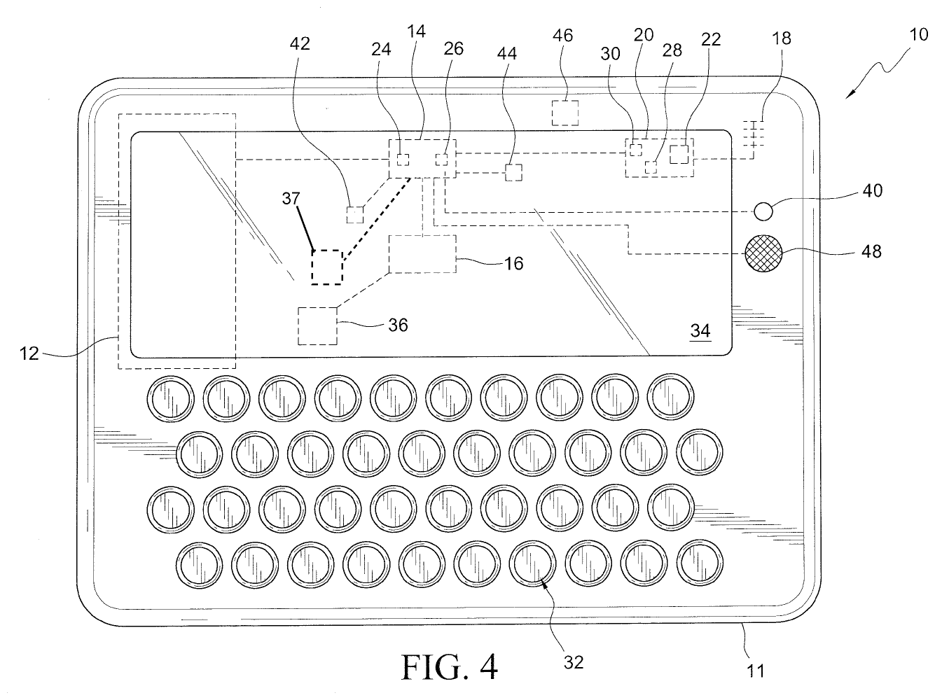

In addition to the functionalities discussed above, and considering the mobile communication texting device 10 is intended to be a “single application use” device, it is contemplated the presented device's ability to send and receive texts may be enhanced by the provision of camera 40 and an associated QR CODE® reader application maintained by the applications processor 26 as shown in the alternate embodiment shown in FIG. 4. As is known to those skilled in the art, a QR CODE® is a type of matrix barcode (or two-dimensional barcode) used as a machine-readable optical label that contains information about an item or service. Further, and also as shown in FIG. 4, the mobile communication texting device 10 may be constructed with NFC (Near Field Communication) enabling circuitry 44 and a removable Secure Digital (SD) card (or other non-volatile memory card) 46. As those skilled in the art will appreciate NFC-enabled devices are capable of reading electronic tags or make payments when connected to an NFC-compliant apparatus. As to the inclusion the SD card 46, such a removable memory will allow for convenient collection of lead information as discussed above. The mobile communication texting device 10 may also be provided with a buzzer 48 to be used in alerting the user 104 in the event of an emergency. Other than the integration of the camera 40, NFC enabling circuitry 44 and the removable SD card 46, and buzzer 48, the mobile communication texting device 10 is the same as that disclosed above with reference to FIG. 1.

It is further appreciated the mobile communication texting device 10 may make use of WAP (Wireless Application Protocol) or other known communication protocols. As those skilled in the art will appreciate, WAP provides the ability to access information over a mobile wireless network. Devices taking advantage of WAP use a WAP browser designed specifically for mobile devices using the protocol.

While the preferred embodiments have been shown and described, it will be understood that there is no intent to limit the invention by such disclosure, but rather, is intended to cover all modifications and alternate constructions falling within the spirit and scope of the invention.

1. A mobile communication system allows for communication in a limited geographic area without the need for conventional communication infrastructure, comprising:
a plurality a mobile communication texting devices operated by users of the mobile communication system, wherein each of the plurality of mobile communication texting devices includes a housing with a battery, a microprocessor, a memory, an antenna, a display device, a GPS module enabling real time detection of a current geographic position of each of the plurality of mobile communication texting devices, a contact tracing module, and a wireless communication module interconnected to provide for communication with other communication texting devices;
a central server operated by a host of the mobile communication system; and
a plurality of mesh routers wirelessly coupled to a gateway node;
wherein the plurality of mobile communication texting devices interact and communicate amongst themselves by utilizing the mesh routers, the gateway node and the central server.

2. The mobile communication system according claim 1, wherein the gateway node is integrated into the central server.

3. The mobile communication system according claim 1, wherein each of the plurality of mobile communication texting devices includes a housing with a battery, a microprocessor, a memory, an antenna, a display device, and a wireless communication module interconnected to provide for communication with other communication texting devices.

4. The mobile communication system according claim 3, wherein the wireless communication module includes a radio transmitter/receiver connected with the antenna.

5. The mobile communication system according claim 1, wherein the mobile communication texting device includes no mechanism for voice communication and is limited to communications via SMS (Short Message Service).

6. The mobile communication system according claim 1, wherein the mobile communication system is part of a cruise ship.

7. The mobile communication system according claim 1, wherein the gateway node is integrated into the central server.
